(19) United States
(12) Patent Application Publication
(10) Pub. No.: US 2007/0052868 A1
(43) Pub. Date: Mar. 8, 2007

(54) Multimedia accessible universal input device

(75) Inventors: Eric Chou, Fremont, CA (US); Ding-Chau Jau, Redwood City, CA (US)

Correspondence Address: STEPHEN B. ACKERMAN, 28 DAVIS AVENUE, POUGHKEEPSIE, NY, 12603, US

(73) Assignee: Charisma Communications, Inc.

(21) Appl. No.: 11/219,491

(22) Filed: Sep. 2, 2005

(51) Int. Cl. H04N 5/44

(52) U.S. Cl. 348/734

(57) ABSTRACT

A multimedia access system has a remote unit coupled to a host computer system, which is used to control and access media files located on the host computer system. The remote unit comprises a plurality of controls, e.g. mouse, cursor, multimedia controls and a numerical keypad. The keypad is used to input code to be coupled to a linguistic input method editor. The code ranges from code for a full descriptive phrase of a media file, a code for a partial phrase to code for initials of the words of the phrase. The linguistic input method analyzer interprets the code and provides a search phrase to find a media file on the host computer to be played. The multimedia system operates with various languages comprising English, Spanish and the Asia languages.

### RELATED PATENT APPLICATION

This application is related to U.S. patent application docket number CH04-001, Ser. No. 10/977,630, filed on Oct. 29, 2004, assigned to the same assignee as the present invention and which is herein incorporated by reference in its entirety.

### BACKGROUND OF THE INVENTION

1. Field of Invention

The present invention refers to a multimedia system and in particular to a method and system for selecting multimedia files using a plurality of languages and a remote device.

2. Description of Related Art

Remote control devices have existed for many years to control electronic systems, e.g. television, VCR, CD and DVD. Each of these remote control devices are designed to fit the particular nature of the individual system. Universal controllers have also been developed that allow the individual to control more than one electronic system including the ability to control lamp modules to activate lights in the home or building. In general these remote control devices are unique to the electronic systems with which they come, and a preponderance of these control devices emit infrared signals.

Computer technology has become very popular to the extent that many people have and use a personal computer. A personal computer usually comes with a keyboard and a rolling and scrolling device called mouse. These computer devices can be attached to the computer by wire or can be wireless and need to be placed on a flat surface even though the device might be wireless.

As the internet technology grows, many applications have emerged. Among these new applications is a technology called voice over internet protocol (VoIP). From this there is a growing trend that people are giving up on a traditional telecom network and switching to a less expensive data communication network having a similar reliability as the traditional data communication network. This trend creates a need to have a device, which can support VoIP application.

The computer has become a device for creating and controlling presentations. Before this, a set of diagrams were created by computer programs and turned into projection slides to be used in a projector during a presentation. A light beam or laser beam pointer was used during the slide presentations to point out to the audience specific areas on the projected image from the slides that the presenter wanted to emphasize.

A computer or information appliance can have other input mechanisms comprising a microphone or tablet input pad. The computer or information appliance can also have audio output devices comprising an earphone or speaker. Audio output devices can be detached from the computer if a transmission media such as an RF technology has been used to transmit signal from the computer to the device.

U.S. Pat. No. 6,331,848 (Stove et al.) is directed to a projection display system comprising a presentation computer that generates images to be projected onto a screen using a projector controlled by the computer. A video camera views the screen and determines a location to which a laser pointer having computer mouse functions is pointed. U.S. Pat. No. 6,416,840 (Daniels) is directed to a communication device communicating control signals to a computer and transmitting a narrow beam of light. The communication device can function as a computer mouse, track ball or touch pad and produces signals to the computer in response to activation of operational buttons or movement of the mouse function. U.S. Pat. No. 6,507,306 (Griesan et al.) is directed to a universal remote control unit for controlling a plurality of electronic devices and having a computer with a plurality of operating modes. U.S. Pat. No. 6,587,067 (Darbee et al.) is directed to a universal remote control having a plurality of buttons, a library of codes and data for use in transmitting operating commands to a plurality of home appliances of different manufacturers. U.S. Pat. No. 6,822,602 (Kang et al.) is directed to a method for generating and processing universal input codes for which a universal remote control protocol is applied, and an apparatus thereof is provided.

The preponderance of a large number of electronic devices ranging from a computer to a variety of multimedia systems establishes a need to provide a remote control like device that integrates together a computer mouse function, a computer keyboard function, a remote control for multimedia functions, a digital phone function, and a pointing device. At the same time the remote control like device needs to provide a size that is small, portable, not requiring a flat surface upon which to rest and allowing text and character communication in a variety of languages, e.g. English, Spanish and Asian languages, to be communicated between the remote control device and the computer system.

### SUMMARY OF THE INVENTION

It is an objective of the present invention to provide an input system and method for a computer and other electronic devices that is cross language and cross platform while providing a small, portable and user friendly configuration.

It is also an objective of the present invention to provide a remote control like device that contains a keyboard function and a computer mouse, or touch pad, function with and without a wired communication between the remote and a computer system.

It is further an objective of the present invention to provide a wireless receiver, which can convert a specific wireless signal into a character-based input stream.

It is also an objective of the present invention to provide a universal serial bus or other common digital interfaces to provide communications between the wireless receiver and a computing system.

It is still further an objective of the present invention to communicate between the remote control like device and the wireless receiver with a plurality of wireless communication methods including infrared and RF signals.

It is also further an objective of the present invention to provide a conversion mechanism to convert an input stream with a limited symbol set into a complete character set and control signals.

It is still further an objective of the present invention to provide an active-window detection algorithm, which can find target software and a proper keyboard mapping file to serve the needs of the application program.

It is still further an objective of the present program to provide a keyboard mapping management tool, which allows users to compile a hot-key mapping assignment for any application, wherein an active window detection algorithm creates a keyboard mapping file for each application program, and wherein the application can be any program, or any browser-based or IP-based software tha allows a remote control-like device to control a remote electronic device.

It is also further an objective of the present invention to provide a input method that can integrate remote control commands, verbal command recognition, and keyboard interface within the same software, wherein the software operates cross-platform with a cross-language control input system that is universal for all computing devices

It is also still further an objective of the present invention to provide a complete indexing system on the computer system that can provide fast indexing for multimedia data access.

It is an additional objective of the present invention to provide multilingual communications between the remote device and a computing system to permit text like communications for a plurality of reasons including controlling a multimedia system and selecting media files located in the computing system.

In the present invention a coded language input from a numeric keypad on a remote unit is used to identify multimedia files that are available to be played using a computer system. The keys of the numeric keypad are used to form number sequences representing letters or words of a language. The number sequences are coupled to a code input system containing a linguistic input method editor (LIME) to interpret the inputted code and search for the existence of a media file on the computer system. Various languages, comprising English, European and Asian languages, are interpreted by LIME which produces a phrase or partial phrase to be compared to descriptive identifiers of media files located on the computer system or the internet. The partial phrases are either in the form of consonants and syllables of the phrase or initials of the words forming the phrase. The descriptive identifiers comprise, title, artist, actor/actress and place of origin. After the LIME has interpreted the inputted code and formed the intended phrase or partial phrase, the input system compares the phrase or partial phrase to a list of multimedia files located on the computer system. Upon finding a match of the phrase or partial phrase to an index of available multimedia files, The particular media file is selected to be played using an appropriate media program, e.g. a music player, a video player and a picture player. The remote unit is then used to input phrases and to control the particular media program being used to play the selected media file.

The remote is coupled to the computer system with infrared, RF signals or a wired connection. Contained on the remote are numeric keypads, cursor controls, a mouse pad and mouse keys, controls for the media player and other control key such as power, menu select and return. The playing of multimedia files are fully selectable and controllable using the remote unit.

Software or hardware driver can have its own keyboard mapping file. The keyboard mapping can be provided by the manufacturer or generated by the user. If the keyboard-mapping file is provided by the manufacturer, it is often downloadable from a web-site and is called Control Panel On Demand (CPOD). The manufacturer is focused on inventing the newest control panel, Allowing the user to get the newest version instead of the version available at the product release time. A control panel program is designed to control a remote program through the internet is called remote-site remote control (RSRC). The present invention supports CPOD and RSRC by allowing the keyboard-mapping editor to adjust keyboard mapping to allow keys on the remote unit to activate functions provided by CPOD and RSRC. The control panel on demand is becoming more popular with home appliances that are encouraged to be connected through the internet to a gateway PC where the gateway PC is the interface for a user to control the home appliance.

### BRIEF DESCRIPTION OF THE DRAWINGS

This invention will be described with reference to the accompanying drawings, wherein:

FIG. 1A is a system diagram of the present invention;

FIG. 1B is a diagram of the input queue of the present invention;

FIG. 2 is a diagram of the remote control device of the present invention;

FIG. 3 is a diagram of the software architecture of the present invention;

FIG. 4 is a method of the present invention for determining a descriptive identifier of a multimedia file using minimum set of letters of the English language;

FIG. 5 is a diagram of the present invention of a table of shapes for the Asian languages;

FIG. 6 is a table of the present invention for selecting for selecting a unit of the Asian Languages;

FIG. 7 is a diagram of the present invention for word filtering using a six-element Japanese code;

FIG. 8 is a diagram of the present invention for word filtering using phonetic preview filters for traditional Chinese;

FIG. 9 is a diagram of the present invention for word filtering using phonetic preview filters for simplifier Chinese; FIG. 10 is a flow diagram of the present invention for the method of playing a media file.

FIG. 11 is a flow diagram of the present invention for the method of communicating text, commands and audio signal with the host computer;

FIG. 12 is a flow diagram of the present invention for the method of media file management;

FIG. 13 is a flow diagram of the present invention for fast indexing for media playback; and

FIG. 14 is a flow diagram of the present invention for automatic keyboard mapping.

### DETAILED DESCRIPTION OF THE PREFERRED EMBODIMENT

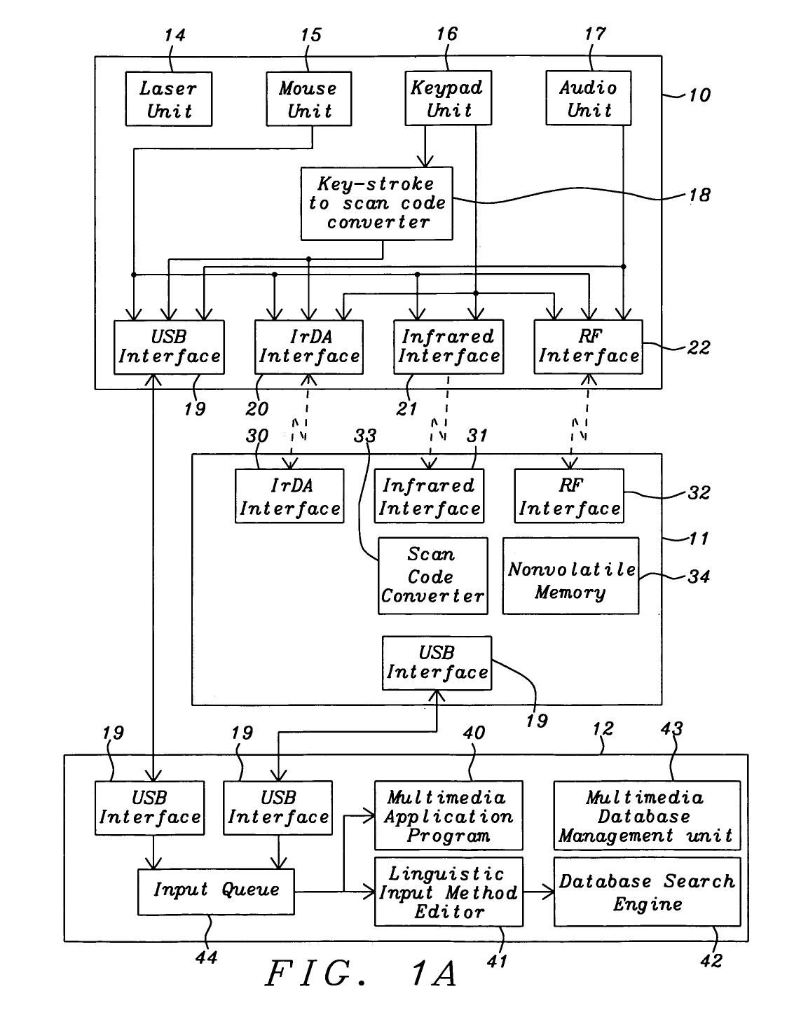

In FIG. 1A is shown a block diagram of the system of the present invention. A remote unit 10, which has universal function and connectivity, is capable of being coupled to a wireless receiver unit 11 by either infrared or RF communications, or to a host computer 12 by an USB connection 19. This provides a flexibility to use the remote in a variety of system configuration.

A laser unit 14 is integrated into the remote unit 10 to be used during presentations. A laser diode (not shown) forms a part of the remote unit and is operated manually to emphasize points of interest during presentations comprising a slide show or a video. A mouse unit 15 is coupled to a mouse pad and right and left mouse keys on the surface of the remote and connects signals to a USB interface 19, an IrDA interface 20 and an RF interface 22 on the remote unit 10. It should be noted that one interface (USB, IrDA or RF) is used at one time. The multiplicity of interfaces allows the remote unit 10 to operate in a variety of system environments. The USB interface 19 is further connected to a USB interface 19 on the host computer 12. Movement of a pointing device, such as by a finger or stylus, on the mouse pad and the selection of the mouse keys creates signals that are coupled to the host computer by the USB connection. A keypad unit 16 is coupled to a twelve key keypad of the remote unit 10 and couples key presses to a wireless interface comprising an IrDA interface 20, an infrared interface 21 and an RF interface 22. This allows the keypad unit to couple signals to a host computer in a system environment where either infrared or RF communication is used. The keypad unit is also coupled to a key-stroke to scan code converter 18 that produces the scan code that is then coupled to the host computer 12 through the USB 19 connection. The audio unit 17 which contains at least a microphone and a earphone or speaker is used to be the user interface for the telephony applications. It requires bi-directional link between the computer and the remote control unit.

The wireless receiver unit 11 receives wireless signals from the remote unit 10 and translates these wireless signals into electrical signals to be coupled to the host computer through an USB connection 19. When signals from the keypad unit 16 are coupled to the host computer 12 through the wireless receiver unit, a scan code converter 33 translates the key press signals from the keypad unit into a code that can be interpreted by the host computer. The wireless receiver unit contains an IrDA receiver 30, an infrared receiver 31 and an RF receiver 32 to provide the capability to receive signals from the remote unit. The purpose of the plurality of wireless communication means is to provide universality with other devices that are coupled to the host computer 12.

A nonvolatile memory 34 is included in the wireless receiver to allow portability of the wireless receiver to other computer systems and become an I/O unit for that system and allow compatibility to the remote unit 10. This will allow compatibility of the remote unit to operate when the host computer 12 key mapping is different than that of the remote unit 10. Additionally the nonvolatile memory can be used to provide a buffer for a digital video device such as a digital camera that is controlled by the remote unit. The multimedia application programs 40, such as those required to display pictures, run video files, and audio (music) files. A linguistic input method editor (LIME) 41 is used to interpret input from the key presses on the remote unit 10 and form the appropriate characters and words for various languages comprising English, Spanish and Asian languages as disclosed in the related patent application Ser. No. 10/977,630, filed on Oct. 29, 2004. The characters and words interpreted by LIME are connected to a database search engine 42 to compare to a listing of various multimedia files that are available from the host computer12 and to allow selection of a multimedia file from the multimedia database 43 by title, artist or other descriptive identifiers of the multimedia file.

The host computer 12 contains software, which includes the input queue 44, the multimedia application program 40 and the linguistic input method editor (LIME) 41. The input queue is further detailed in FIG. 1B, which includes an input buffer 440 that receives data from the remote unit 10 either through a direct USB 19 connection or through the wireless unit 11 connected to the host computer 12 by a USB connection. The input buffer receives scan code, mouse signals and audio signals from the wireless receiver 11 or the USB interface 19 from which the various codes are directed to the various units in the host computer. Audio signals 441 in the form of commands are directed to speech pattern recognition software 442 to convert the audio signals into keyboard scan code 445 that can be interpreted by application programs 40. The speech recognition algorithm is trained by the user to recognize basic words comprising “Play”, “Pause”, “Stop”, and “Rewind” and convert them into a code word that substitutes for the code word for the controls and keypad entry 443 produced by the receiver unit 11.

A keyboard mapping editor 446 is used establish the keyboard mapping 448 that is needed to control specific application programs, which have control code not necessarily shared with other applications. The keyboard mapping 448 converts the keyboard scan code 445 into control code for detected applications 447. The keyboard mapping connects control data to the multimedia program 40 resident in the host computer 12 and connects text data to the LIME editors 41 to allow searching the multimedia data base using the chosen language 42. Mouse control signals 444 are connected from the input buffer 440 to the mouse control of the operating system of the host computer, and VoIP signals 449 are connected to an internet connection to the host computer to allow voice over the internet protocol for making voice messaging.

The keyboard mapping is necessary because the remote control unit has limited number of keys while the same function for different programs may have different input key requirements. In order to provide seamless transfer from one key mapping to another, an automatic key detection algorithm is used. The detection program senses the title of the current active, and based on the title name determine the keyboard mapping. The automatic key detection program assists the input queue 44 to find the appropriate keyboard mapping without manual operations by the user.

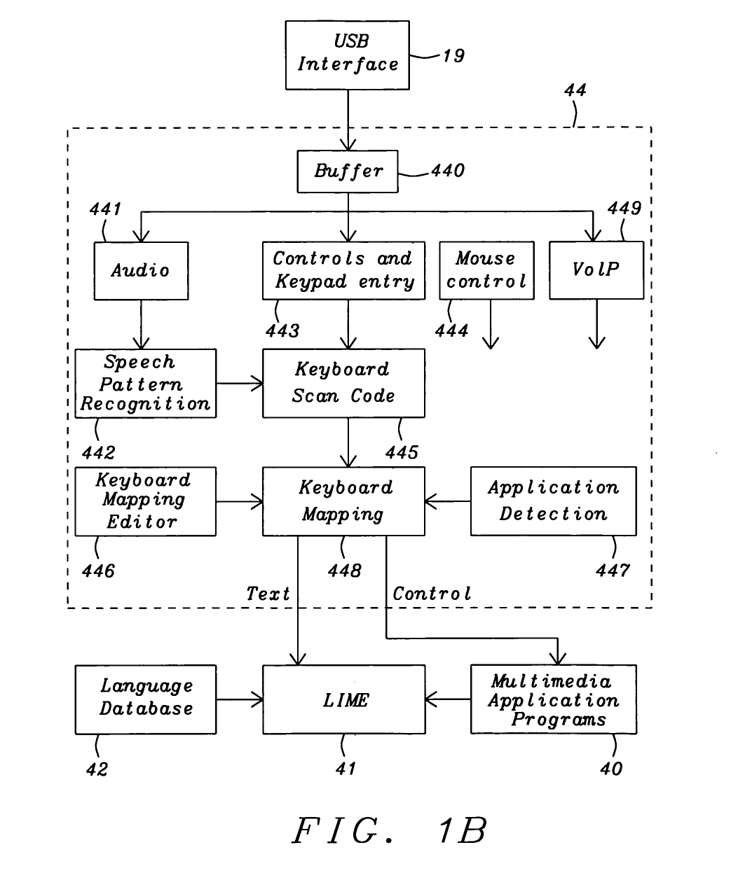

In FIG. 2 is shown an example layout of keys and controls for the remote unit 10. There is a set of key pads for media selection and control 50 including menu selection (Menu), information selection (Info), volume control (Vol− and Vol+), channel selection (Ch− and Ch+). A computer mouse control section 51 is provided, which includes a mouse pad 52, or an equivalent mouse control, for example a mouse ball, left and right mouse keys (L and R), an escape key (ESC) and a mute key (Mute). The mouse pad 52 allows the computer mouse to be controlled from the remote unit 10 using a pointing device comprising a finger, stylus and writing instrument. A keypad section 53 provides twelve keys organized similar to a telephone keypad for data entry, a select key, a backspace key (BKspace), an insert key (INS) and a delete key (DEL). The number keys (1 to 0) allow code entry for various languages, similar to the related patent application Ser. No. 10/977,630, filed on Oct. 29, 2004, for communicating to the LIME 41 to allow selection of various multimedia files.

A speaker 55 and a microphone 56 are integrated into the remote unit 10 to facilitate VoIP (voice over Internet protocol) and to provide voice commands to be interpreted by speech pattern software, which results in commands for directing the operation of media programs. An audio connector 57 is provided to allow the attachment of a headset for audio purposes. The audio connector 57 is shown as a raised area on the side of the remote unit and does not necessarily imply either the location or the physical disposition of the connector. A laser pointing device 59 is integrated into the remote unit 10 and is manually activated by an “L” button 58 when pressed by the user of the remote device to allow pointing to specific features of a slide show or video presentation. The laser pointing device 59 is shown for demonstration purposes as a raised area on the side of the remote unit and does not necessarily imply either the location or the physical disposition of the pointing device.

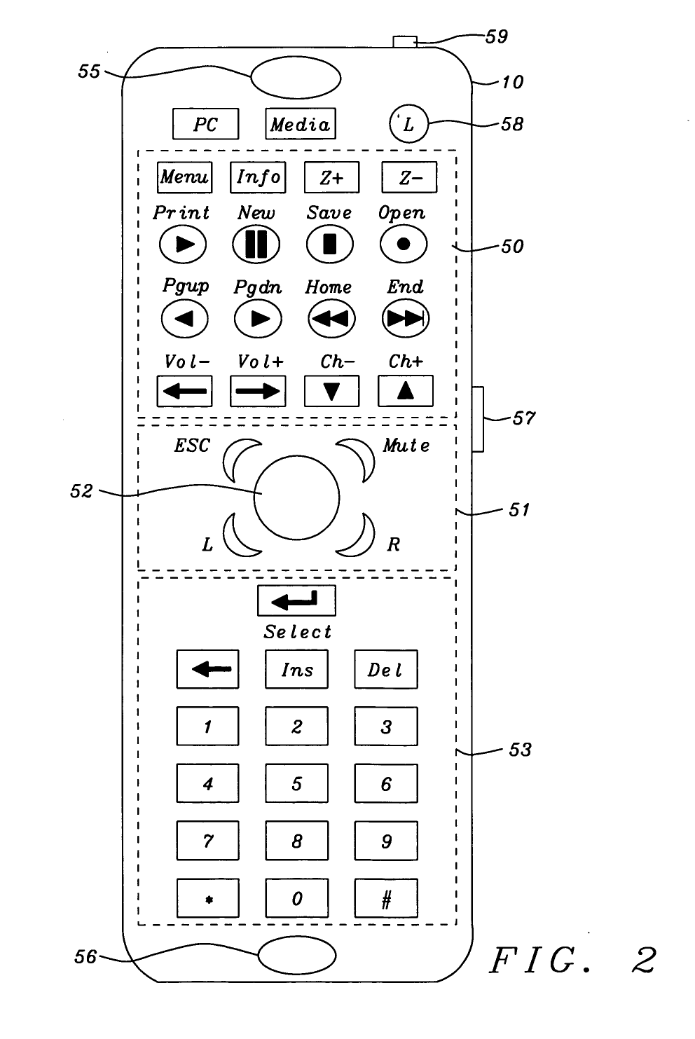

In FIG. 3 is shown the software architecture for the multimedia access system 60 of the present invention. An introductory page 61 contains a menu of selectable multimedia options available on the host computer comprising pictures, movies, music, TV, games, shopping. Also on the start page is the capability to select a language that will be used to identify a descriptive identifier of a media file. The descriptive identifier is a term or phrase that identifies the media file comprising title, artist or actor/actress, date created, country and language. The user presses Menu on the remote unit 10 (FIG. 2A) to display the selectable multimedia options including the language that will be used to select a media file. By using the cursor controls 50 (FIG. 2A), or the mouse controls 52, the user selects item from the menu by selecting Return to indicate to the host computer of the selection that is made. The language selection comprises English, Spanish and the Asia languages. Once the media type and language is chosen, the user chooses the input system that is to be used to define a search for a media file resident on the host computer 10 (FIG. 1).

There are three input systems used to find the multimedia available on the multi-access system 60 each using the linguistic input method editor (LIME) to interpret the code from the entry of data on the numerical keypad of the remote unit. The first is a full code input system 62 in which a complete descriptive identifier is keyed into the numerical keypad 53 of the remote 10, interpreted by the LIME editor to create a complete descriptive identifier and compared to an index of media available on the host computing system 12 to select a media file. The second is a partial code input system 63, which interprets a partial descriptive identifier, for instance a few words of a title, that is keyed into the numeric keypad and compares these first few words to a few words of an index of descriptive identifiers comprising titles, for instance, of the media available on the host computer to select the media file being sought. The third is the initial code input system 64, which interprets initials of words of the descriptive identifier, that is keyed in on the numeric keypad and compares the initials to the initials of the words in an index of the descriptive identifiers of the media files available on the host computer to select the media file that is being sought. It is possible that more than one of media files on the host computer will have a match to the input for the partial and initial code input systems. When this occurs the system will present to the user the media files matching the partial and initial input code for visual selection.

The selected index file 65 is coupled to the media access unit 66 that selects from the index data base 67 the media file location and couples the location to media player programs, comprising a music player program 68, an image player program 69 and a video player program 70. The appropriate player program then accesses the selected media file from the collection of media 71 that are accessible on the host computer and that have been registered 72 in the index data base 67. Control key data from the remote unit 73 is coupled to the media access unit 66 to control the operation of the media players 68, 69 and 70.

The number of data entry keys available on the remote unit 10 is quite limited compared to a standard computer key board; therefore, an efficient method of entering words and phrases is needed to be able to use the numerical keypad in an efficient manner. To that end, a key code table named vertical input code (VIC) table was created to accommodate the data entry for English and Spanish words, for example, in conjunction with the use of a phonetic filtering method. The phonetic filtering method can be used with other languages comprising European, Asian, African and Pacific regions. Perhaps easiest to understand is phonetic filtering for the English language, which will be explained next.

A VIC table organized with lower case letters for English and Spanish in the first few columns is shown in TABLE 1.

TABLE 1

| | 2^{nd} | | | | | | | | | |
|---|---|---|---|---|---|---|---|---|---|---|
| 1^{st} | 1 | 2 | 3 | 4 | 5 | 6 | 7 | 8 | 9 | 0 |
| 1 | ! | @ | # | $ | % | \hat{ } | & | * | ( | ) |
| 2 | a | b | c | á | − | A | B | C | Á | + |
| 3 | d | e | f | é | [ | D | E | F | É | ] |
| 4 | g | h | i | í | < | G | H | I | Í | > |
| 5 | j | k | l | ˜ | = | J | K | L | { | } |
| 6 | m | n | o | ñ | ó | M | N | O | Ñ | Ó |
| 7 | p | q | r | s | i | P | Q | R | S | _{—} |
| 8 | t | u | v | ü | ú | T | U | V | Ü | Ú |
| 9 | w | x | y | z | [symbol] | W | X | Y | Z | / |
| 0 | . | , | : | ; | ? | ‘ | \grave{ } | “ | \ | space |

The alphabetic letters for English are arranged in rows similar to the assignment of these letters on a standard telephone keypad. For instance, the “2” key on a telephone keypad can also represent the letters a, b, c and this assignment is shown in TABLE 1 in the second row. The letter “a” is in the first column of the second row, the letter “b” in the second column and the letter “c” in the third column. Similarly, the third row contains the letters d, e, f that are assigned to the number “3” key of a telephone keypad; the fourth row contains g, h, l as with the number “4” key of a telephone; the fifth contains letters j, k, l corresponding to the “5” key of a telephone; the sixth row contains letters m, n, o corresponding the “6” of a telephone; the seventh row contains letters p, q, r, s corresponding to the “7” key of a telephone; the eighth row contains letters t, u, v corresponding to the “8” key of a telephone; and the ninth row contains letters w, x, y, z corresponding to the “9” key of a telephone keypad. Using TABLE 1 to enter letters of the English language into the numeric keypad on the remote requires two key presses for each letter, for instance to enter the letter “n” the first key press would be the “6” key followed by the “2” key and to enter the letter “s” the first key pressed would be the “7” key followed by the “4” . The TABLE 1 is organized in this manner to make it easy to remember which keys are assigned to the alphabetic letters, particularly if the letters are printed in order onto the keypads.

Table 1 also provides special PC keyboard symbols in row “1”, punctuation characters in row “0” and mathematical characters in parts of columns “5”, “9” and “0” . Spanish words can also be formed using TABLE 1 by selecting, for instance, “n” by first pressing the “6” keypad followed by the “4” keypad. To accommodate uppercase letters a VIC table, TABLE 2, is accessed when the shift key on the numerical keypad of the remote unit. Table 2 only differs from TABLE 1 in that the uppercase letters replace the lower case letters in TABLE 1, allowing the same code entry for a particular upper case letter that follows the press of the shift key. This makes it easy and convenient for the user to press the right combination of keys rather than having to remember to add five to the second key press number to obtain an upper case letter. Thus an “N” can be accessed by pressing “shift” followed by pressing the “6” key followed by the “2” key, and an “Ñ” can be accessed by first pressing the “shift” key followed by pressing the “6” key then the “4” key.

TABLE 2

| | 2^{nd} | | | | | | | | | |
|---|---|---|---|---|---|---|---|---|---|---|
| 1^{st} | 1 | 2 | 3 | 4 | 5 | 6 | 7 | 8 | 9 | 0 |
| 1 | ! | @ | # | $ | % | \hat{ } | & | * | ( | ) |
| 2 | A | B | C | Á | − | a | b | C | Á | + |
| 3 | D | E | F | É | [ | d | e | F | É | ] |
| 4 | G | H | I | Í | < | g | h | I | Í | > |
| 5 | J | K | L | ˜ | = | j | k | L | { | } |
| 6 | M | N | O | Ñ | Ó | m | n | O | Ñ | ó |
| 7 | P | Q | R | S | i | p | q | R | S | _{—} |
| 8 | T | U | V | Ü | Ú | t | u | V | Ú | ú |
| 9 | W | X | Y | z | [symbol] | w | x | Y | Z | / |
| 0 | . | , | : | ; | ? | ‘ | \grave{ } | “ | \ | space |

In order to shorten the required number of keystrokes for English and Spanish, for example, a phonetic method similar to that used for the Japanese language is used for languages having structure similar to English and Spanish. The syllable for an English word is divided into consonants and rhymes. For example, consonant combinations for the letter “s” will comprise in part s, sc, scr, sh, sk, sl, sm, sn, sq, sp, spr, st, str, and rhyme combinations comprise in part for the vowel “a” an, at, ap, am, ab, ace, act, ar, are, al, all, alt, ale with similar rhyme combinations for “e”, “i”, “o” and “u”. The combinations for consonants and rhymes are limited sets, and the resulting combinations of consonants and rhymes are limited and a manageable number without the need to use a large dictionary to find complete words. The system discussed herein supports one thousand most popular English words, which along with a phonetic preview, allows the user to efficiently choose a word using the numerical keypad of the remote unit.

In TABLE 3 is shown an example of coding letters of the English language with numbers that can be used by the multimedia access system 60. If a number is assigned to represent each letter, the number “2” for “a”, “b” and “c”; the number “3” for “d”, “e”, and “f”; the number “4” for “g”, “h”, and “i”; the number “5”for “j”, “k”, and “l”; the number “6” for “m”, “n”, and “o”; the number “7” for “p”, “q”, “r”, and “s”; the number “8” for “t”, “u”, and “v”; and the number “9” for “w”, “x”, “y”, and “z”; then there will be a pool of words and partial words (called candidate roots herein) within the combination of the consonant blends and rhymes and the plurality of most frequently used words (one thousand for instance) that can be efficiently accessed by the user when using the numerical keypad on the remote unit to input a media descriptor to the multimedia access system. In TABLE 3 is an example of candidate roots and the key code associated with them by pressing the number “8” on the numerical keypad of the remote unit, or any other unit or device with a numerical keypad that is connected to a computing system that contains the multimedia access system or any derivative thereof.

TABLE 3

| Candidate | Key Stroke | Candidate | Key Stroke |
|---|---|---|---|
| t, u, v | 8 | ton | 866 |
| tal | 825 | tong | 8664 |
| tall | 8255 | tul | 885 |
| tan | 826 | tung | 8864 |
| tang | 8264 | tup | 8877 |
| tar | 8267 | tur | 887 |
| tear | 8327 | ug | 884 |
| ten | 836 | um | 886 |
| teng | 8364 | up | 887 |
| ter | 837 | url | 8875 |
| tin | 846 | van | 828 |
| ting | 8464 | var | 827 |

In TABLE 3 each letter is coded with only one number (the row number) from the VIC table shown in TABLE 1 and TABLE 2. Using the predictive input capability of the multimedia access system using consonant blends and rhymes for the English and Spanish languages into eight groups (2 to 9). Each group is divided into sub-groups and then additional sub-groups by the next level of roots creating a code tree called a recursive partial phonetic code tree. Possible root candidates are shown in a root preview window similar to that shown in TABLE 4, which uses a method called the predictive phonetic preview method.

The English language has many origins. The roots of word come from many languages, comprising Latin, French, Spanish, Greek and other languages. In the input system of the present invention, a word root glossary is included. The word roots are treated in the same way as normal word. For example, there is a word root “ac” and a corresponding word list. A user can enter a code for a word by entering on the numerical keypad of the remote unit “2226868”, for example. Or, the user can enter “22” to find “ac” and then, “26868” to find the appropriate word. An English dictionary can have more than 100,000 words. Storing all of these words in to a small electronic device is not efficient since many of the words have a low probability of being used in the multimedia device of the present invention; therefore, careful selection of a word root selection is important to maintain storage in the device to useful word roots associated with multimedia files. If by chance that a word root is not available to allow rapid determination of a descriptive identifier of a particular media file, a full entry of the identifier can be entered using the numeric keypad of the remote device.

An example of the phonetic preview is shown in TABLE 4 using a partial code input. A phrase “Springs is a good time for” is being entered from the numerical keypad of the remote unit. The next key press is “8”, which displays “t, u, v, T, U, V” in the phonetic preview screen. The user can select a letter or enter a next code number. If the user next presses a “7”, the phonetic preview screen will show “tr, ur, up, us”. The user can make a selection or press the next numeric key, for instance “2”, which yields, for example, “tra, track, tract, trade, travel, traffic, urban . . . ” in the phonetic preview screen. If the appropriate word is found, a selection can be made by positioning the cursor at the desired word using the cursor controls on the remote unit 10 and selecting the word by pressing the “#” key on the numeric keypad, or the next code number can be entered. If the user next presses the “8” key, the phonetic preview screen displays, for instance, “travel, Travis”. Again the appropriate word can be chosen, or the code number “3” representing letters “d, e, f” can be entered, which selects “travel” in the example given. The word “travel” is selected by pressing the “#’ key on the keypad, or if there is more than one word, the cursor can be controlled to select “travel” and then the “#” key pressed to select the word. The code word for “travel” is “87283”, and the phrase becomes “Spring is a very good time to travel”.

If a full code input is chosen, the code for “travel” would be “817321833253”, where t=81,r=73, a=21, v=83, e=32 and l=53. The partial code word “87283” is much more efficient, but requires that the word “travel” be apart of the library of words contained within the multimedia system of the present invention. When a word is not stored within the system the full code input is necessary to create the required word.

TABLE 4

| | | Code |
|---|---|---|
| Action | Phonetic Preview | Word |
| Phrase being entered | “Spring is a very good time for” | |
| Next key press | “t, u, v, T, U, V” | 8 |
| Select or press next key | “tr, ur, up, us” | 7 |
| Select or press next key | “tra, track, tract, trade, travel, | 2 |
| | traffic, urban . . . ” | |
| Select or press next key | “travel, Travis . . . ” | 8 |
| Select or press next key | “travel” | 3 |
| Pressing “#” to select | “travel” | 87283 |
| Phrase | “Spring is a very good time for | |
| | travel” | |

The code word for the word “travel” in TABLE 4 becomes “87283” where “r” or “7” is the only candidate in row “2” and “d” followed by “e” is the only candidate in row “3”. Otherwise the code word for “trade” would be “8123213132” as can be seen from TABLE 1 using row and column code entry. In some cases the user may have to enter the full code word because the phonetic preview and editing does not result in the desired word.

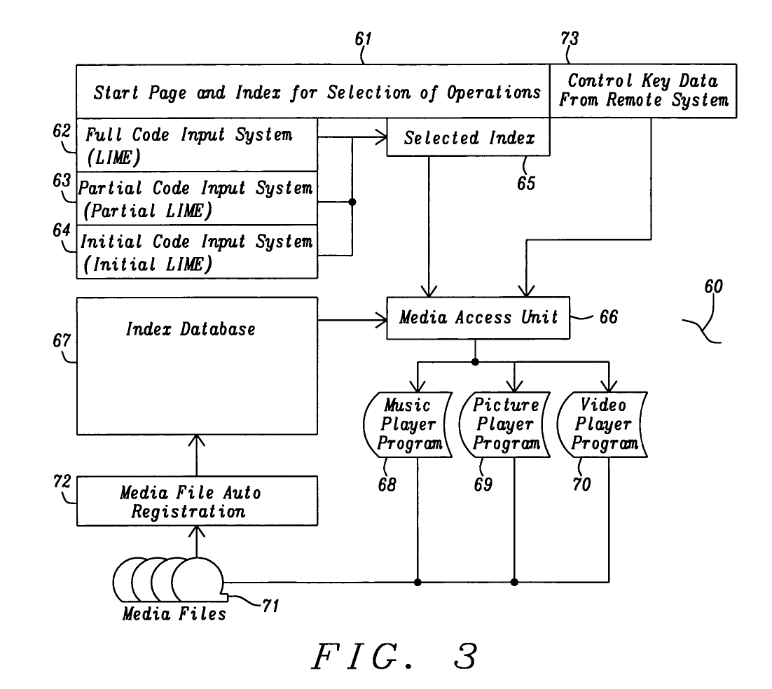

In FIG. 4 is shown an example of the method of partial code entry to select a multimedia file. The shift key is pressed 89 and then the first letter is keyed into the numerical keypad 90. If the number “9” key on the numerical pad is pressed after shift key, the system begins to look for words beginning in W, X, Y, or Z. When a second letter 91 is entered by pressing the number “3” key, the multimedia access system looks for rhymes of words that begin “We”, “Xe”, “Ye” or “Ze” since the only rhyme available with the number “3” key of the numerical keypad begins in “e”. When the third letter is entered 92, a space, the system make the easy choice of the word “We” and begins to search the list of registered media files beginning with “We”. At this point if there is only one multimedia file beginning with “We”, the number of additional key presses are unnecessary. If there are pluralities of multimedia files available that begin with “We”, then a fourth letter is entered 93. If the fourth letter is an “a” by pressing the number “2” key, the system begins to look for additional words with a combination of letters beginning with the letter “a”. When the fifth letter 94 is entered by pressing the number “7” key the system looks for rhymes such as “apple”, “aqua”, “aquit”, “are”, “as” and the available words from the list of most common words. The system compares the possible combinations, for instance “We are” by choosing “are” as the second word and presents to the user “We are the world” as a multi media file to be selected. There could be a second multimedia file “We are the children”, for example. If there are more than one multimedia file having a title beginning “We are”, the system present the multimedia files to the user to be chosen. If neither multimedia file title matches the user's requirements then additional key presses are required.

If the initial code input system 64 (FIG. 3) is used “We are the world” could be determined by entering “Watw” or “9289” and the initial code input system would search the media files on the host computer having words that begin with the initials “W” for “We”, “a” for “are”, “t” for “the” and “w” for world. The input code “9289” might produce just one multimedia file “We are the world for children” or additional titles of other selections from which the user could make a choice or enter additional initial code.

Whether the initial code 64 (FIG. 3), full code 62 or partial code 63 input system is used depends on the target database. For example, if the target is a database of sing-along songs such as in an iPod, the number of songs in the database could be around several hundreds to several thousands. Using partial code or full code input system will not be efficient. There might be several songs which have similar names: “We are the word.”, “We are the boy scout”, “We are the Saviors”, and “We are the friends”. The partial code or full input code system will require the user to input many identical letters and still not differentiate the songs. The initial code input system provides a faster solution. If the target database system is a dictionary, the initial code input will not be definitive enough, and the partial code input is more optimal. If the alphabetical characters of a word or full phrase are to be input, full code input system is used. The method of code entry is therefore dependent upon the application

For the Japanese language there are three types of characters or letters, Hiragana, Katakana and Kanji. TABLE 5 shows a table of Hiragana organized to provide input to the multimedia access system 60. The TABLE 5 is organized to determine a letter by the entry of a number from the numeric keypad 53 of the remote unit 10 first by row and then by column. A particular letter is chosen by first pressing a number on the numerical keypad of the remote unit 10 to select a column and a second press of a key pad to select the row in which the Hiragana letter resides. TABLE 6 shows a table organized in a similar way to allow input from the remote unit 10 to the multimedia access system 60 to determine a letter of Katakana using a first key press to select a column and a second key press to select the row in which the Katakana selected letter resides.

TABLE 5

| 1^{st} | | | | | | | | | | |
|---|---|---|---|---|---|---|---|---|---|---|
| 0 | 9 | 8 | 7 | 6 | 5 | 4 | 3 | 2 | 1 | 2^{nd} |
| 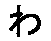 | 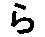 | 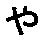 | 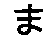 | 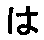 | 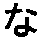 | 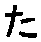 | 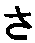 | 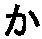 | 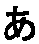 | 1 |
| 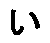 | 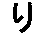 | 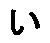 | 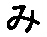 | 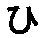 | 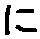 | 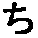 | 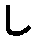 | 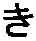 | 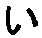 | 2 |
| 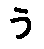 | 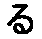 | 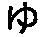 | 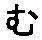 | 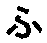 | 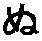 | 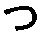 | 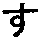 | 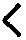 | 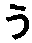 | 3 |
| 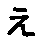 | 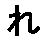 | 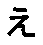 | 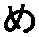 | 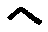 | 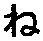 | 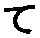 | 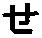 | 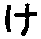 | 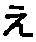 | 4 |
| 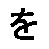 | 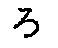 | 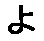 | 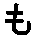 | 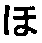 | 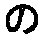 | 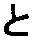 | 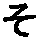 | 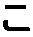 | 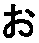 | 5 |
| | | 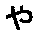 | | 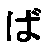 | 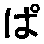 | 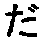 | 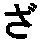 | 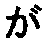 | | 6 |
| | | | | 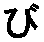 | 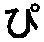 | 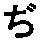 | 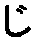 | 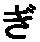 | | 7 |
| 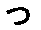 | | 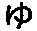 | | 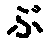 | 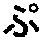 | 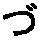 | 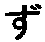 | 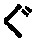 | | 8 |
| 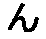 | | | | 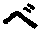 | 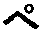 | 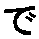 | 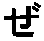 | 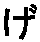 | | 9 |
| space | | 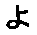 | | 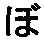 | 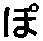 | 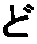 | 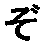 | 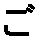 | | 0 |

TABLE 6

| 1^{st} | | | | | | | | | | |
|---|---|---|---|---|---|---|---|---|---|---|
| 0 | 9 | 8 | 7 | 6 | 5 | 4 | 3 | 2 | 1 | 2^{nd} |
| 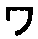 | 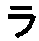 | 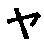 | 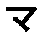 | 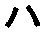 | 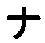 | 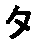 | 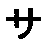 | 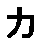 | 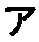 | 1 |
| 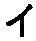 | 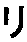 | 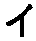 | 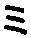 | 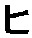 | 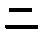 | 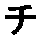 | 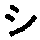 | 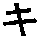 | 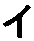 | 2 |
| 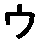 | 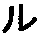 | 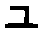 | 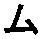 | 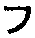 | 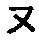 | 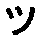 | 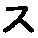 | 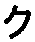 | 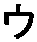 | 3 |
| 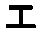 | 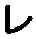 | 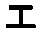 | 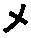 | 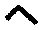 | 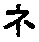 | 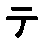 | 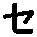 | 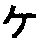 | 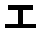 | 4 |
| 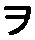 | 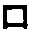 | 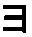 | 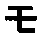 | 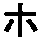 | 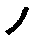 | 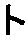 | 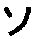 | 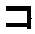 | 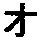 | 5 |
| | | 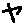 | | 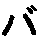 | 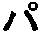 | 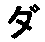 | 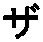 | 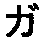 | 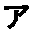 | 6 |
| | | | | 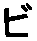 | 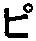 | 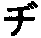 | 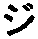 | 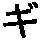 | 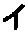 | 7 |
| 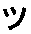 | | 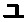 | | 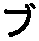 | 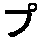 | 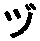 | 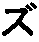 | 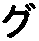 | 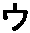 | 8 |
| 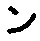 | | | | 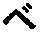 | 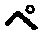 | 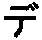 | 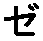 | 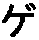 | 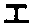 | 9 |
| space | | 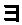 | | 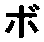 | 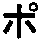 | 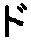 | 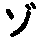 | 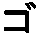 | 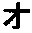 | 0 |

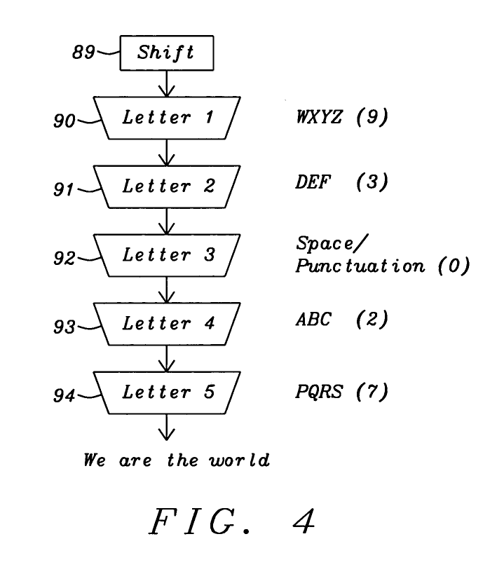

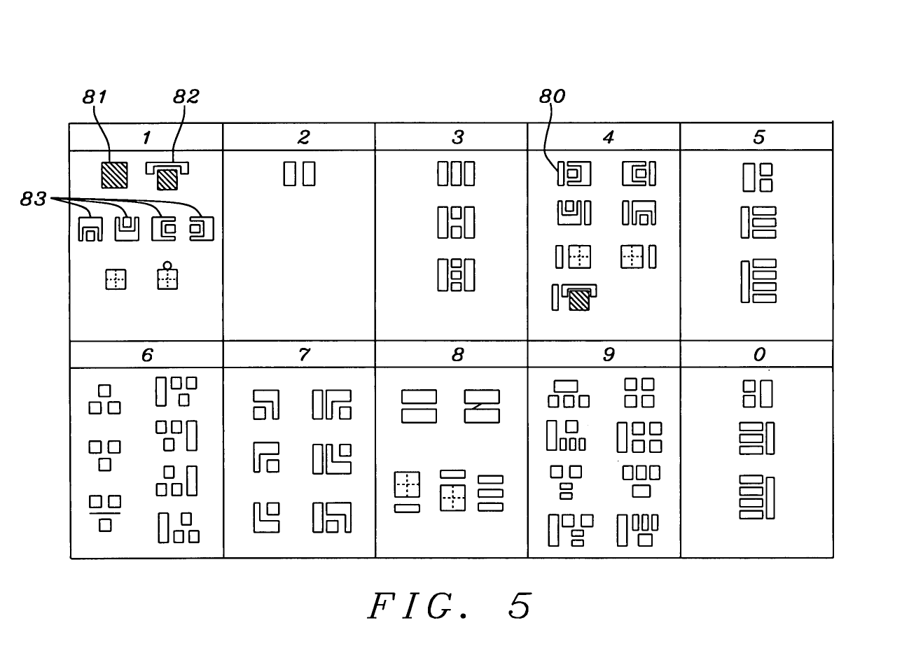

The third set of Japanese characters is Kanji, which has approximately two thousand frequently used characters, and a large number beyond that. In order to create code for the Kanji characters a six element phonic input method is shown in TABLE 7. The first column shows a Kanji, Hiragana or Katakana character. Each Kanji character requires one to six Hiragana characters to describe its sound and may only need as few as one to three Hiragana characters. A uniform code is formed by choosing the first two Hiragana codes for the Kanji character. Each Hiragana and Katakana pronunciation is assigned two code number pairs, column and row, from TABLE 5 and 6. The definition of shape and unit are defined in the related patent application Ser. No. 10/977,630, filed on Oct. 29, 2004, and presented herein in FIG. 5 and FIG. 6 as reference. Before continuing with a description of TABLE 7, a description of FIG. 5 and FIG. 6 follow.

Shape is the fifth code digit six-element phonic input method shown in TABLE 7. The Chinese character is divided into ten word-shape characteristics as shown in FIG. 5. Each group of shapes shown is headed by a number, which is the number entered as a fifth digit into the six-element phonic code code. The first shape group associated with the code number “1” of has a shape containing a single body, or structure with and with out a cover 82. The crosshatched box 81 represents any single bodied character, for example “-” meaning one, [symbol] meaning east, [symbol] meaning center. The cover 82 can be seen in the character for home [symbol] which has a cover 82 [symbol] over the character for pig [symbol] , which means “some pigs covered by a safe cover.” The four characters 83 located in the middle of the box for code number “1” appear to be multi-bodied but they are characters of a single column, for example [symbol] meaning giant and [symbol] meaning district. The second shape group associated with the code number “2” contains two pieces of a Chinese word that are separated horizontally, for example the character for double [symbol] The third shape group associated with the code number “3” contains three pieces of a Chinese word that are separated horizontally, for example the character for river [symbol] The fourth shape group associated with the code number “4” contains a plurality of pieces of a Chinese word in which a “stroke” is encircled on all four sides 80, for example [symbol] meaning country. Stroke is a term that relates to how a Chinese word is drawn when writing the word by hand. The fifth shape group associated with code number “5” contains one piece of a word on the left and two pieces on the right, or one piece on the right and two pieces on the left, for example the character for love [symbol] The sixth shape group associated with the code number “6” has a triangle like structure, which contains one piece of a Chinese word on top and two pieces of the word below the top piece or two pieces of the word on top and one piece of the word below the two top pieces, for example the character for six [symbol] The seventh shape group associated with the code number “7” contains Chinese words in which there is a bent stroke at one corner of the word, for example the character for windshield [symbol] The eighth shape group associated with the code number “8” contains two or more parts of a Chinese word that are separated vertically such that one part is over a second part, for example the character for bath tub [symbol] The ninth shape group associated with the code number “9” is used for any Chinese word that does not fit the definition for the other groups, for example the character for random [symbol] The tenth shape group associated with the code number “0” is used for a Chinese word that has a shape group “8” to the left and a shape group “1” to the right, for example the character for age [symbol] The rules associated with shape of the Chinese word (character) are basic and are applied to all Chinese characters without exception. If the rules associated with groups “2”, “4”, “5”, “6”, “7”, “9” and “0” contradict each other then the following order of rules are taken “0”, “9”, “4”, “6”, “7”,“5” and “2” to resolve the contradiction.

In FIG. 6 is shown a code table for the unit code, which is the sixth code element of the phonic input method shown in TABLE 7. The unit code element can be a plurality of decimal digits each of which use the definitions listed in FIG. 6. The unit code digit “1” relates to words with a vertical line in the center, for example characters [symbol] [symbol] [symbol] The unit code digit “2” relates to complicated words, for example characters [symbol] [symbol] [symbol] The unit code digit “3” relates to words with a three way fence, for example characters [symbol] [symbol] [symbol] The unit code digit “4” relates to words with a four way fence, for example characters [symbol] [symbol] Unit code digit “5” relates to words with a flat ceiling, for example characters [symbol] [symbol] The unit code digit “6” relates to words with a dot and slides on top, for example characters [symbol] [symbol] The unit code digit “7” relates to words with a [symbol] in the middle, for example characters [symbol] [symbol] [symbol] The unit code digit “8” relates to breaking words, for example characters [symbol] [symbol] The unit code digit “9” relates to words with a curved bottom, for example [symbol] [symbol] [symbol] The unit code digit “0” relates to words with a dot and words with an X at the bottom, for example

[symbol]

[symbol]

[symbol]

TABLE 7

| | Pronunciation | | | | | | | |
|---|---|---|---|---|---|---|---|---|
| | By Hiragana or | | | | | | | 6-element |
| Kanji | Katakana | Column | Row | Column | Row | Shape | Unit | code |
| 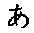 | 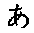 | 1 | 1 | 0 | 0 | 0 | 0 | 110000 |
| 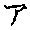 | 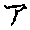 | 1 | 1 | 0 | 0 | 0 | 1 | 110001 |
| 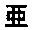 | 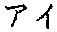 | 1 | 1 | 0 | 0 | 1 | 5 | 110015 |
| 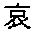 | 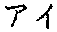 | 1 | 1 | 1 | 2 | 8 | 6 | 111286 |
| 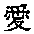 | 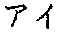 | 1 | 1 | 1 | 2 | 8 | 8 | 111288 |
| 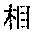 | 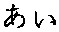 | 1 | 1 | 1 | 2 | 4 | 7 | 111247 |
| 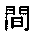 | 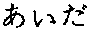 | 1 | 1 | 1 | 2 | 1 | 8 | 111218 |
| 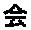 | 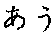 | 1 | 1 | 1 | 3 | 1 | 0 | 111310 |
| 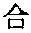 | 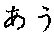 | 1 | 1 | 1 | 3 | 1 | 9 | 111319 |
| 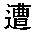 | 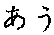 | 1 | 1 | 1 | 3 | 7 | 9 | 111379 |
| 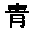 | 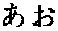 | 1 | 1 | 1 | 5 | 8 | 6 | 111586 |
| 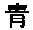 | 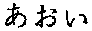 | 1 | 1 | 1 | 5 | 8 | 6 | 111586 |
| 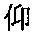 | 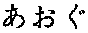 | 1 | 1 | 1 | 5 | 3 | 2 | 111532 |
| 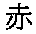 | 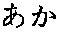 | 1 | 1 | 2 | 1 | 1 | 6 | 112116 |
| 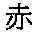 | 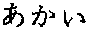 | 1 | 1 | 2 | 1 | 1 | 6 | 112116 |

Continuing the discussion of TABLE 7, the integration of Hiragana, Katakana and Kanji uses a six element phonetic input method. The Hiragana and Katakana symbols are treated as one Hiragana Kanji symbol. The last two code digits have “0, 0” for Hiragana and “0, 1” for Katakana as shown in the first two rows of TABLE 7. By entering on the numerical keypad “1” followed by a “1” the Hiragana letter [symbol] will, be entered into the system. If the remaining code digits are “0” as shown in the first row of TABLE 7, a six-element character [symbol] with code “110000” will be entered into the system. If the last code digit is a “1” as shown in row two, the Katakana letter [symbol] will be entered into the system as shown in the second row of TABLE 7, and the Katakana symbol [symbol] is shown in the second row and second in the column for “Pronunciation by Hiragana”, which demonstrates a Katakana pronunciation root, and the six-element code for [symbol] is “110001”. The third Kanji character [symbol] has a Katakana pronunciation root, but there is not any additional Katakana characters that represent the third Kanji character [symbol] Therefore, the second column and row entry for Katakana are filled with the number “0”, and the shape and unit code is selected from FIG. 5 and FIG. 6, respectively, to produce a shape code of “1” and a unit code of “5”, yielding a six-element code “110015”. In the fourth row the Kanji character [symbol] has a Katakana pronunciation root [symbol] signified by the Katakana character [symbol] in the “Pronunciation” column, and the second column and row code that is entered into the numerical keypad of the remote unit is the number “1” followed by number “2”, which selects [symbol] from the first column and second row of the Katakana table, TABLE 6. The shape and unit code for the Kanji character [symbol] is shape=8 and unit=6 yielding a six element code of “111286” for the Kanji character [symbol] The symbolism of the Katakana character [symbol] in the pronunciation column exemplifies that the next character in the column for the row representing [symbol] is found in the Katakana Table 6. In the sixth row of TABLE 7 is the Kanji character [symbol] that has a Hiragana pronunciation root [symbol] found in the Hiragana table, TABLE 6, in column 1, row 2; therefore the second column-row entry is column=1 and row=2. The shape and unit code for [symbol] “4” and “7”, respectively, yielding a six element code, “111247”, to be entered into the numeric keypad. The “Pronunciation” column in TABLE 7 begins with [symbol] to signify that the pronunciation has a Hiragana root. In the seventh row of TABLE 7 is the Kanji character [symbol] that has the Hiragana pronunciation root [symbol] which is two characters [symbol] and [symbol] The first character [symbol] is located on the Hiragana TABLE 5 in column 1 and row 2, which is entered into the second column and row. The second character for the Hiragana pronunciation root is not used. The shape and unit for [symbol] is shape=1 and unit=8, yielding a six-element code of “111218”.

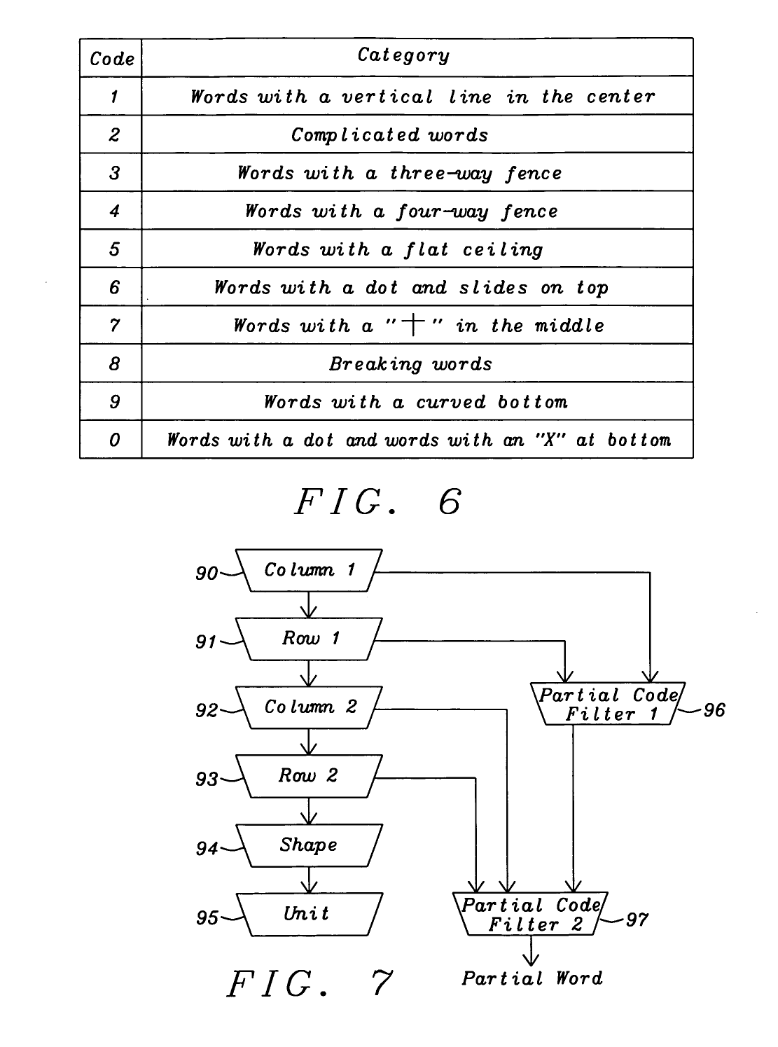

The Hiragana and Katakana characters are treated as one Hiragana-Kanji character where a Hiragana character will be assigned a number “0” in the shape and unit columns and a Katakana will be assigned a number “0” for shape and a number “1” for unit in the phonetic input. as shown in FIG. 7. By entering the numbers “1” followed by a second “1”, the Hiragana character [symbol] will be shown as the very first Japanese word that is selected. The remainder of the code assignment will be “0000” if the character to be selected is [symbol] The Katakana character [symbol] will be shown in a second position in the pronunciation column in TABLE 7 and then the code for Kanji characters [symbol] will follow as shown in TABLE 7. Hiragana is considered as Japanese phonetic symbols, and these phonetic symbols are be shown in a phonetic status window so that the user can use the phonetic symbol to select the target letters.

A conceptual diagram is shown in FIG. 7 for a phonetic word filtering method using a six-element Japanese code. There are six basic filters called [symbol] (column-row-column-row-shape-unit). Each filter represents a selection of one word. The first column [symbol] filter 90 represents a column in TABLE 5 for Hiragana to partially choose a letter of the Hiragana language. The column number is entered into the numeric keypad of the remote unit 10, or any other numeric keypad coupled to the host processor 12 (FIG. 1). The user then enters a number representing the location in the row of TABLE 5 into the first row [symbol] filter 91 to complete the choice of the first Hiragana letter. The second column [symbol] filter 92 show in FIG. 7 represents a column in TABLE 6 for the Katakana language. A number representing a column of the Katakana table is entered by a user onto a numeric keypad to partially choose the Katakana letter. Then the user enters the row location of the Katakana letter into the second row [symbol] filter 93. If there is no Katakana letter, which forms the base of the Kanji word that is being determined, then zeros are entered for the second column and second row. The last two filters are for shape 94 and unit 95 of the Kanji character as described in FIG. 5 and FIG. 6. In addition to these six filters 90, 91, 92, 93, 94, and 95 there are two partial code filters 96 and 97, which allow the user to choose phonetic combinations to narrow down the number of possible combinations.

Continuing to refer to FIG. 7, for the first partial filter 96, if the Kanji character [symbol] [symbol] meet) is the target character, the first Hiragana letter will be [symbol] located in the second column (“K” column) in the Hiragana table (TABLE 5). In the “K” column there are ten possible Hiragana letters, [symbol] (ka), [symbol] (ki), [symbol] (ku), [symbol] (ke), [symbol] (ko), [symbol] (ga), [symbol] (gi), [symbol] (gu), [symbol] (ge), and [symbol] (go). The ten Hiragana letters are shown in a preview window for the user to select. If the user selects [symbol] (ka), for example, only Kanji characters which start with the syllable [symbol] (ka) will be left in the selection list for the Kanji character. The second partial filter 97 is used for the second Hiragana letter [symbol] (i). To use the phonetic word filtering method the user selects the method from a menu. Then enters numbers representing the rows and columns of TABLE 5 and 6. To select the Kanji character [symbol] the user enters “2” on the numeric keypad of the remote unit 10. The Hiragana characters [symbol] [symbol] are displayed in a partial filter window. The user then enters “1”, which selects [symbol] The user can also position the cursor at the desired character and use the select key on the remote unit to select the desired character. The user next enters “1”, the number for the column of the second Hiragana character, and the partial filter window displays [symbol] The user then selects the desired Hiragana by entering a number on the numeric keypad or positioning the cursor at the correct selection and pressing the select button. In this example the desired Hiragana is [symbol] which partially represents the Kanji character [symbol] and the number that is entered by the user is “2”, which identifies the second row in TABLE 5.

Once the two Hiragana letters are chosen, then the user can selects the shape (FIG. 5) and the unit (FIG. 6) to complete the selection of the Kanji character by entering onto the keypad the appropriate code numbers. Or the user can submit the partial code to the partial code input system 63 (FIG. 3) to form a search word seeking a match with multimedia files contained within the host computer 12 (FIG. 1). If a full Kanj1 word is required, the code created by the user is coupled to the full code input system 62, (FIG. 3), which presents the Kanji character(s) to the multimedia system to search for the appropriate media file.

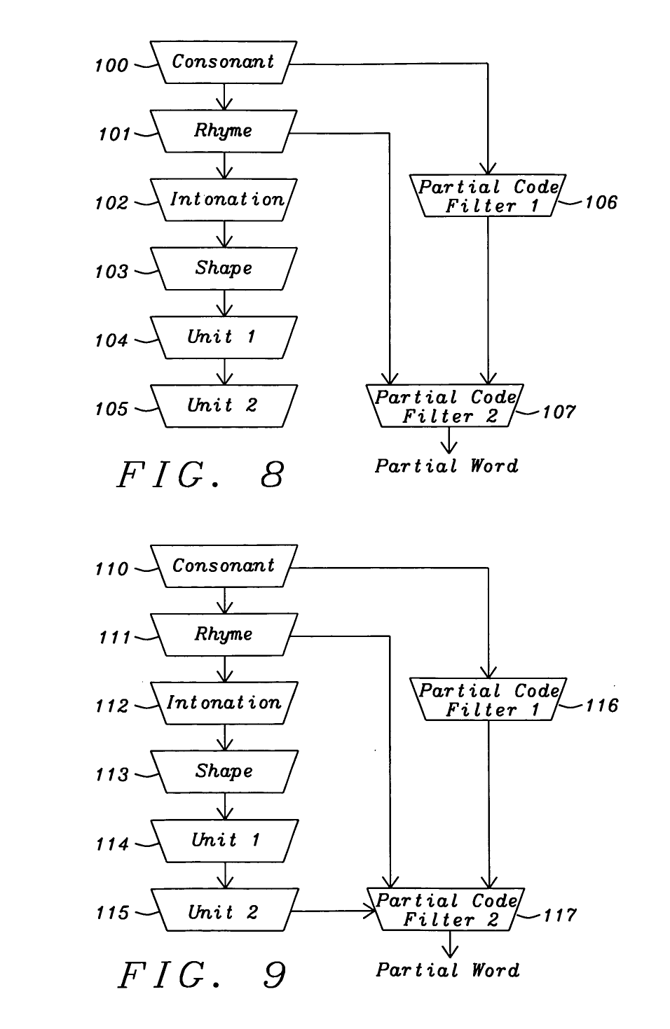

In FIG. 8 is shown phonetic filtering used for Traditional Chinese. There are six basic filters, consonant [symbol] [symbol] 100, rhyme [symbol] [symbol] 101, intonation [symbol] 102, shape [symbol] 103, first unit [symbol] t 104 and the second unit [symbol] 105. These basic filters are presented in the related patent application Ser. No. 10/977,630, filed on Oct. 29, 2004. There two additional phonetic filters, a first partial code filter 106 and a second partial code filter 107. The first partial code filter 106 is a consonant filter and the second partial code filter 107 is a syllable filter. The first partial code filter 106 is used to determine which consonant is to be chosen. Each of the number keys on the numeric keypad is assigned with a plurality of consonants, for example key “1” represents consonants [symbol] (B) and [symbol] (P). The first partial code filter allows the user to choose which of the two that is wanted to help minimize the set of consonant candidates. The second partial code filter 107 is used with the rhyme filter 101. After a key on the numeric keypad is pressed to enter a rhyme, for example key “8” there will be a key combination a “1” from the first example and an “8” from the second example. A preview window will show syllables [symbol] and [symbol] for the user to make a selection, which minimizes the set of word candidates and which aids the search for a Chinese word.

After the partial code has been determined, the partial code is used by the partial code input system 63 (FIG. 3) to locate a multimedia file. If this is not successful then a complete Chinese word can be formed using the consonant-rhyme-intonation-shape-unit1-unit2 and input this full code to the full code input system 62 (FIG. 3). The partial code development provides a shortcut method for the user to find a multimedia file without the need to enter all the code necessary to define the complete Traditional Chinese character or characters that are a part of the descriptive identifier of the multimedia file, which the user wants to play. If a full Chinese character is required, then once the rhyme determined with the partial code filters 106 and 107 the user enters code for intonation 102, shape 103, unit “1” 104 and unit “2” 105 as described in detail in the related patent application Ser. No. 10/977,630, filed on Oct. 29, 2004. The partial code determination provides a short cut for finding a multimedia file located on the host computer 12 (FIG. 1). The partial code is coupled to the partial code input system 63 (FIG. 3), which then searches the host computer for the intended multimedia file. If a full code is necessary, the full code is coupled to the full code input system 62 (FIG. 3).

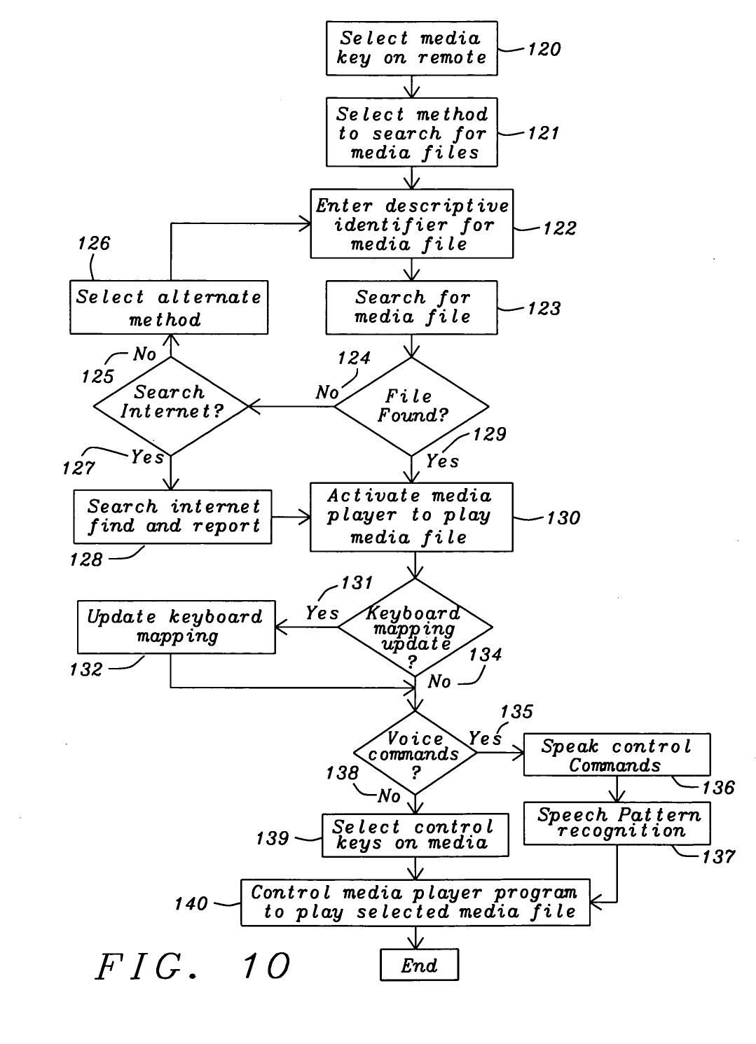

In FIG. 9 is shown phonetic filtering used for Simplified (modern) Chinese. Similar to that shown in FIG. 8, there are six basic filters, Consonant [symbol] 110 (B, P, M, F, D, T, N, K, etc.). Rhyme [symbol] 111 (a, o, e, ie, i, etc.), Intonation [symbol] 112, Shape [symbol] 113, First Unit [symbol] 114 and Second Unit [symbol] 115. There are two additional filters for phonetic preview. The first is a partial code filter “1” 116, which is a consonant filter, and the second is a partial code filter “2”, which is a syllable filter. The first partial code filter 116 for consonants helps the user to determine which consonant assigned to a key of a numeric keypad is to be selected. The second partial code filter 117 is used after a keypad entry for a rhyme 111. The second partial filter 117 will present to the user on a computer monitor all possible syllables associated with the selected consonant 110. For example, if the number “1” key on a numerical key pad is pressed to choose a consonant, the consonants associated with the number “1” key are “B” and “P”. If next the number “8” key is pressed for rhyme 111 then the second partial code filter will cause to be displayed on the computer screen in a phonetic preview window all the possible syllables associated with the selected consonant for the user to choose amongst. Therefore, pressing the number “8” key for a rhyme will display for the user to choose amongst syllables such as Bian, Pian, etc. If “B” is chosen with the first partial code filter “Pian” is eliminated.

After the partial code has been determined, the partial code is used by the partial code input system 63 (FIG. 3) to locate a multimedia file. If this is not successful then a complete Simplified Chinese word can be formed using the consonant-rhyme-intonation-shape-unit1-unit2 and input this full code to the full code input system 62 (FIG. 3). The partial code development provides a quick method for the user to find a multimedia file without the need to enter all the code necessary to define the complete Simplified Chinese character or a plurality of characters that are a part of the descriptive identifier of the multimedia file, which the user wants to play.

If a full Simplified Chinese character is required once the rhyme of the Chinese word is determined using the partial code filters 116 and 117, the user enters code for intonation 112, shape 113, unit “1” 114 and unit “2” 115 as described in detail in the related patent application Ser. No. 10/977,630, filed on Oct. 29, 2004. This is much more tedious and time consuming, but the capability is there to be used if required.

It should be noted that the techniques noted herein are applicable to other systems requiring an input of letter, word and or characters of various languages comprising Asian (further comprising Chinese, Japanese, Korean, Thai, etc.), English, European and other languages that can be coded for access by a numeric keypad. European languages use a same input algorithm but with different word databases.

A start page and software for the multimedia management system is located on the host computer 10 (FIG. 1). The software is coupled to the input system. In addition, the software has a real-time demon (control) program, which keeps track of all of the multimedia data files on the hard disk of the host computer. By applying an indexing technology, each multimedia file is associated with a search key. The search key is useful when a user browses through the hard disk using the starting page. For example, if the song “We Are the World” has been downloaded to local hard disk, a partial code index key of “9302730843096753” is generated or an initial code index key of “9289” is generated. The partial code or initial code index usage depends on the computer configuration and the applications. The demon program removes an entry from the index when the multimedia file is removed from the computer system. When a user searches, or browses, through the multimedia database to locate a file, the user may use the index to find a file. Once the file is located, the system will automatically activate the appropriate player program such as a video or music. When a player program is activated to play a multimedia selection, a keyboard-mapping demon maps the control keys of the remote unit 10 (FIG. 1) to accommodate the functions of the player program. In the present invention, a remote unit controls multimedia operations of a host computer ranging from browsing and searching a multimedia data base on the computer, or on the internet, to running a selected media file on an appropriate media program and controlling the operation of the media program.

In FIG. 10 is shown a flow diagram of a method of playing a media file using the remote unit 10 (FIG. 1A) to select the media file and subsequently controlling the media program used to read or play the media file. Using the remote unit the media key is selected 120 and using a menu page displayed on the host computer display screen, the method of searching for the desired media file is selected 121.

Using the numeric keypad of the remote unit, a descriptive identifier for the media file is entered 122. The descriptive identifier of the media file comprises the title, artist or date released. The host computer is searched for the media file 130 using the full code input system 62 (FIG. 3), the partial code input system 63 or the initial code input system 64. If the initial code input system is first used and the file is not found 124 and if the internet is not the possible source, an alternate method using the partial code input system or the full code input system 126.

The descriptive identifier is re-entered for the new chosen method 122 and the hard drive of the host computer is again searched 123. If the media file is not found 124 an Internet search is chosen 127. Upon finding the media file on the internet, the media file is imported into the host computer 128 and the media player that can run the media file is activated 130. If while searching the hard drive of the host computer the media file is found 129, the media player is automatically activated 130 to display or play the media file.

If the keyboard mapping requires updating to allow proper control of media player by the remote unit 131, the keyboard mapping is updated 132 using the keyboard-mapping editor 446 (FIG. 1B). The keyboard mapping is updated by the user to choose particular control keys or by an update file downloaded from the media program creator. If the keyboard mapping does not require updating 134 and if voice commands are used 135, the user speaks voice commands using the remote unit audio capability 136. The voice commands comprise control command such as start, stop, play, pause, backup, and forward. The voice commands are detected using speech pattern recognition 137 and converted into keyboard scan code, which is the same code produced by pressing a control button on the remote unit.

If voice commands are not used 138, control keys on the remote unit are selected 139 to control the media player program. The keyboard scan code from the remote is coupled to the keyboard mapping function from which the media player is controlled to play the selected media file 140. Either or both the voice commands and the keyboard entered control commands can be used alternately to control the media program.

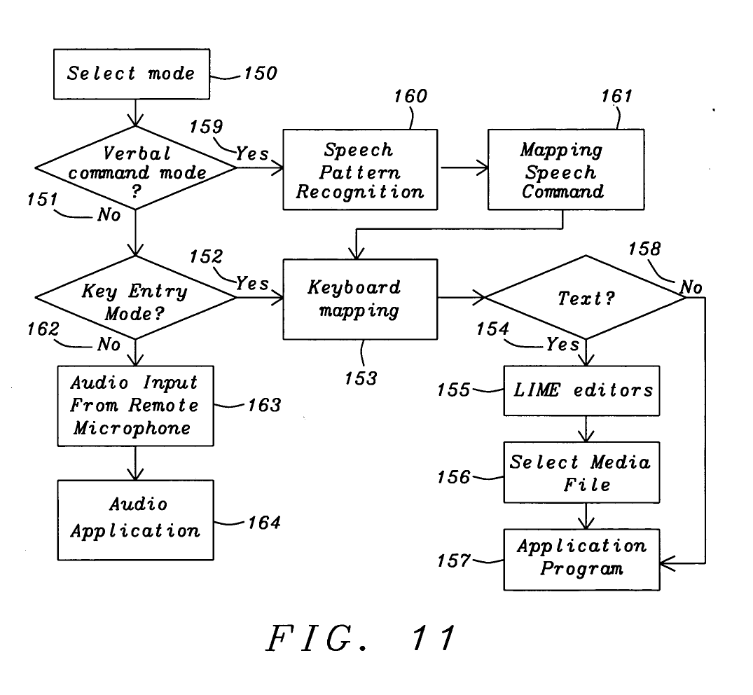

In FIG. 11 is shown a method of the present invention for communicating commands, text, and audio signals with the host computer. Using the remote unit 10 (FIG. 1A) a mode 150 is selected. If the selected mode is not for a verbal command 151 and if the mode is key entry 152, then the data from the remote unit is coupled to a keyboard mapping function 153. The keyboard mapping function translates the code of the key presses on the remote unit into code recognized by the host computer and the media application program that will be used to play a particular media file. If the data is text data 154 to be entered on the numeric keypad of the remote unit 10, the text data is coupled to the LIME editors 155. Once a descriptive identifier is created by the LIME editors, the descriptive identifier is used to select a media file 156 to be played on a media application program 157. If the data from the remote is not text 157, but commands from the control keys on the remote, the data in the form of keystroke code is couple to the application program 157 that is playing a selected media file.

Continuing to refer to FIG. 11, if the command mode is for verbal commands 159, verbal data from the remote unit 10 is coupled to a speech recognition function 160. The output of the speech recognition 160 is coupled to map the speech command 161 into a code representing a keystroke function of the remote 10. The mapping of the speech command 161 is coupled to the keyboard mapping function 153, which translates the interpreted verbal command into code for an equivalent keystroke of the remote unit that can be recognized by the host computer and the application program, and couples the coded verbal command to the keyboard mapping function 153. If the data from the remote unit 10 is neither verbal commands 151 or key entry 162 and is audio input from the remote unit 163, for instance VoIP communications, then the audio data from the remote is coupled to an audio application 164 running on the host computer.

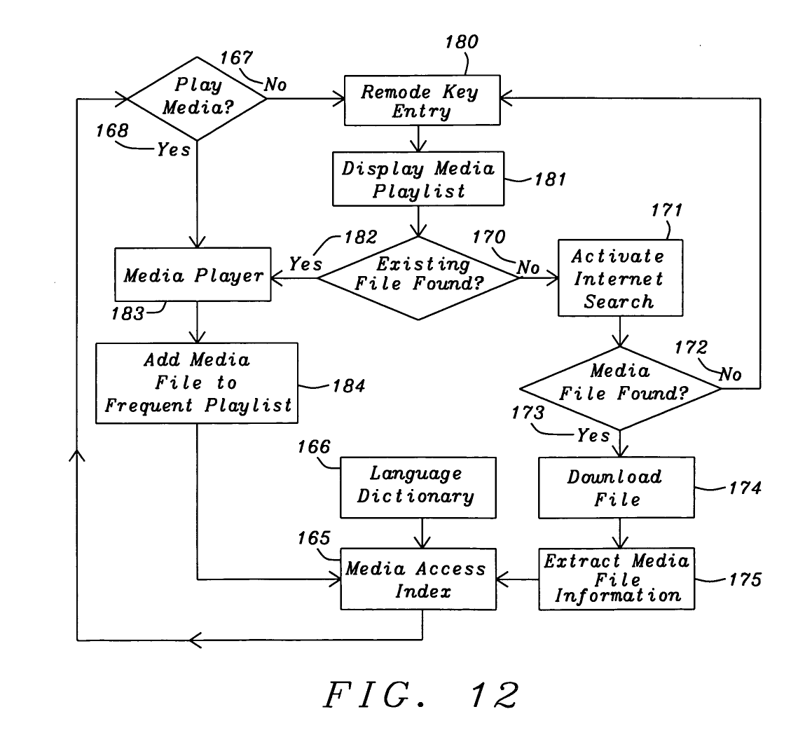

In FIG. 12 is shown a flow diagram of the present invention for a method of media file management. A user using the control keys 180 on a remote unit 10 (FIG. 1A) displays a media play list 181 on a display screen of a host computer 12. Using the cursor controls 51 (FIG. 2), the user searches the play list for a media file. If the media file is found 182, the media file is selected and the appropriate media player 183 is selected to play the media file. The media file is added to a frequent play list 184 and to a media file access index 165, if previously not done. If the media file is not to be played 167, the system returns to waiting for the user to select the next action using the remote key entry 180. If the media file is to be played 168, the appropriate media player 183 is activated to play the media file.

If the media file is not found 170 while searching the media play list, an Internet search is activated 171. If the media file is not found while searching the internet 172, the system returns to waiting for the user to select the next action using the remote key entry 160. If the media file is used while searching the Internet 173, the file is downloaded 174, media file information is extracted 175, and the media access index 165 is updated supported by the language dictionary 166. The media file information comprises descriptive identifiers of the media file further comprising title of the media file, name of artist or performer, category of the media file and date.

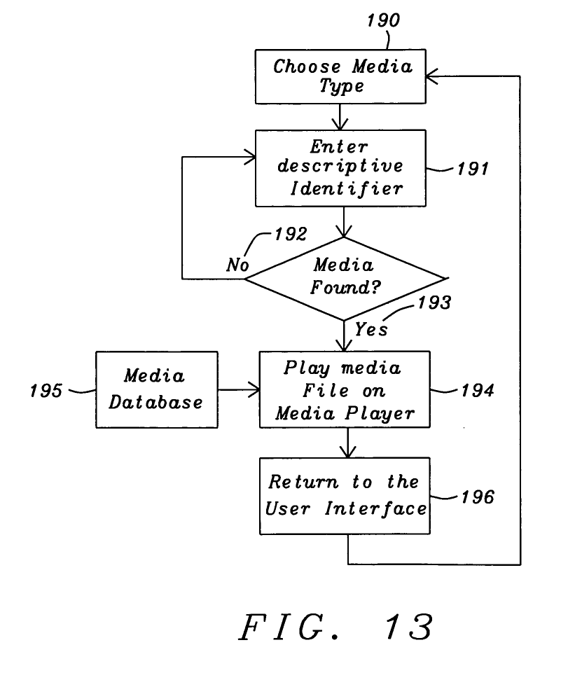

In FIG. 13 is shown a flow diagram of the present invention for fast indexing for media playback. The user selects the media type 190 comprising video, movie, games, music, pictures, and learning programs. Using the numeric keypad of the remote (or the host computer) a descriptive identifier is entered 191 and coupled to the LIME editors of multimedia access system 60 (FIG. 3). The user creates a series of key code using a numeric key pad that is translated into a full phrase, partial phrase or initials of the words of a descriptive identifier of a media file. The multimedia access system uses the series of translated key codes to search a media index to locate a desired media program. When the media file is found, the media file is loaded into memory from a media database to be played on media program. If a desired media file is not found 192, the system returns to entering the descriptive identifier 191. If the desired media file is found 193, the desired media file located in the media database 195 is played on an appropriate media player 194. When the selected media file has been played, the system returns to the user interface 196 from which another media type 190 can be chosen.

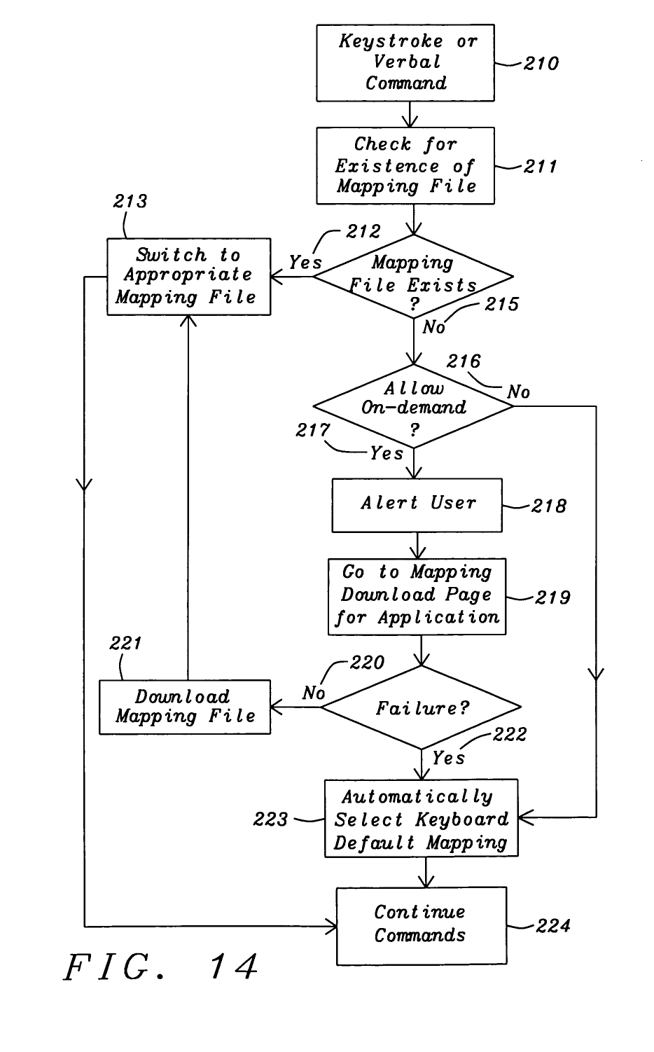

In FIG. 14 is a flow diagram of the present invention for automatic keyboard mapping. A user can issue either keystroke commands or verbal commands 210 from the remote unit 10 (FIG. 1). These commands are used to control multimedia programs resident on the host computer 12. Once a command is issued 210, a check by the multimedia access system to determine if the key code of the remote unit has been previously mapped into code that is recognized by an application program. If the key code from the remote unit has been mapped 212, the appropriate mapping file is used 213 and the user continues to produce commands 214 to operate and control the media program, If key mapping does not exist 215 and if on-demand is not allowed 216, a default keyboard mapping is automatically selected 223. If on-demand is allowed 217, the user is alerted that the system is about to go to the Internet to download keyboard mapping for an application. The system through connection to the Internet is directed to a download for a particular media application 219. If there is no failure in the Interconnection 220, the mapping file is downloaded 221, and the system switches to the appropriate mapping file 213. If there is a failure 222 in the connection to the Internet or the application mapping download page, the default mapping is automatically selected 223, whereupon the user continues to produce commands 224 from the remote unit to control the selected media program.

While the invention has been particularly shown and described with reference to preferred embodiments thereof, it will be understood by those skilled in the art that various changes in form and details may be made without departing from the spirit and scope of the invention.

What is claimed is:

1. A multimedia system, comprising
a) a remote unit coupled to a host computer through a receiver unit;
b) a control program resident in said host computer;
c) said remote unit couples multimedia commands to said receiver unit to activate and control multimedia programs in said computer and select multimedia files using a linguistic input method editor (LIME) to interpret character code input from a numerical entry key pad of said remote unit; and
d) said control program interprets commands from said remote unit to permit selection of a media file from descriptive identifier code entered by a user of said remote unit and to activate a media program to run said media file where a keyboard mapping function maps control commands from said remote unit into said control commands of said media program.

2. The system of claim 1, wherein said remote unit further comprises:
a) a cursor control to control the cursor of the host computer;
b) a play and record control for multimedia files;
c) a mouse pad and right and left mouse buttons;
d) a laser unit to provide a pointer for multimedia presentations; and
e) an audio unit for providing voice commands and voice over Internet protocol (VoIP) communications.

3. The system of claim 1, wherein said remote unit communicates to said receiver unit through RF signaling.

4. The system of claim 1, wherein said remote unit communicates with said receiver unit through infrared signaling.

5. The system of claim 1, wherein said remote unit communicates directly with said host computer unit whereby said remote unit contains a key-stroke to scan code converter to provide to the host computer the proper code for said key stroke on the remote unit.

6. The system of claim 1, wherein said receiver unit further comprises;
a) a wireless communication unit for communicating with said remote unit;
b) a scan code converter to convert key strokes of said remote unit into proper code for said host computer;
c) a nonvolatile memory to contain a conversion table for the remote unit to allow portability of the receiver unit and remote unit to a plurality of host computer units; and
d) a standard connection interface to said host computer.

7. The system of claim 1, wherein said host computer unit further comprises:
a) an input queue for receiving commands and data from the remote unit and the receiver unit;
b) a plurality of multimedia programs;
c) a multimedia database management unit for storing, indexing and running said multimedia;
d) a LIME editor to interpret input from the character entry key pad on said remote unit; and
e) a data base search engine coupled to said LIME editor to select multimedia files from the character input on the character entry key pad.

8. The system of claim 7, wherein the input queue further comprises:
a) an input buffer for receiving and dispersing data from the remote unit;
b) an audio unit for coupling audio commands to a speech pattern unit to produce keyboard scan code to control multimedia programs;
c) a keyboard mapping editor to allow mapping of the remote unit keys to match a control criteria of the multimedia programs; and
d) a keyboard mapping unit to translate key presses on the remote unit into an appropriate set of commands determined by the keyboard mapping editor.

9. The system of claim 8, wherein the keyboard mapping editor is modified by control panel on demand (CPOD) and remote-site remote control (RSRC), whereby CPOD provides a latest control program for multimedia programs and RSRC provides control for applications controlled by a remote site.

10. The system of claim 7, wherein the LIME editor further comprises:
a) a full code input system which interprets character code to identify a complete phrase defining a descriptive identifier for said multimedia file that is being requested;
b) a partial code input system which interprets a partial descriptive identifier for said multimedia file that is being requested; and
c) an initial code input system which interprets initials of words forming said descriptive identifier for said multimedia file that is being requested.

11. A multimedia access system, comprising:
a) an operation selection;
b) a linguistic input method editor (LIME);
c) a media access unit;
d) a media player program;
e) a plurality of media files;
f) a index database; and
g) said operation selection allows a choice of a type of media that is to be selected, whereby the LIME editor interprets an input from a character entry key pad of a remote unit to search the index database and select a media file from said plurality of media files that is to be process by said media player program selected from said operation selection index.

12. The system of claim 11, wherein said remote unit provides control signals to said media access unit to control operation of said media program.

13. The system of claim 11, wherein the LIME supports a plurality of languages, comprising English, Spanish and Asian languages.

14. The system of claim 11, wherein said player program further comprises:
a) a music player program;
b) an image player program; and
c) a video player program.

15. The system of claim 11, wherein said index database contains information pertaining to said plurality of media files, which further comprises:
a) a title;
b) an author;
c) an actor, actress or singer;
d) a date created; and
e) a country or language of origin the multimedia file.

16. A method for selecting multimedia files using a key pad on a remote device, comprising:
a) selecting a language;
b) selecting a media type;
c) selecting keys of a numerical keypad to create a descriptive identifier of a media file;
d) coupling code for said keys to a multimedia access system;
e) interpreting said code with a linguistic input method editor (LIME) and comparing the interpreted code in said selected language to a list of descriptive identifiers for said selected media type;
f) selecting a media file with said descriptive identifier by matching interpreted code to said descriptive identifiers; and
g) choosing manually said media file when said interpreted code matches the descriptive identifier of a plurality of said media files.

17. The method of claim 16, wherein interpreting said code with a linguistic input method editor (LIME) further comprises:
a) a full code input system for interpreting a complete phrase and matching the complete phrase to the descriptive identifiers of available media files;
b) a partial code input system for interpreting a partial phrase and matching the partial phrase to the descriptive identifiers of available media files; and
c) an initial code input system for interpreting initials of words of a phrase of descriptive identifiers and matching the initials to descriptive identifiers of available media files.

18. The method of claim 17, wherein said partial code input system uses a partial code of descriptive identifiers to form a partial code comprising consonants and syllables to identify said media files.

19. The method of claim 17, wherein said initial code input system uses a first letter of each word of a phrase to match to the first letter of each word of the descriptive identifier to select said media files.

20. The method of claim 17, wherein selecting said language further comprises English, Spanish and Asian languages amongst other languages.

21. The method of claim 20, wherein said LIME uses a vertical input code (VIC) table for English and Spanish languages.

22. The method of claim 21, wherein said VIC table is organized in ten rows and ten columns, and organized for ease of use on a ten key numerical keypad on said remote device, where alphabetic characters are organized in rows related to character assignment of each key of a telephone keypad starting at a second row of said ten rows in a first column and extending to a number of columns necessary to accommodate each alphabetic characters assigned to each said telephone keypad.

23. The method of claim 22, wherein capital letters in said VIC table replace lower case letters when a shift button is pressed.

24. The method of claim 21, wherein said LIME uses a plurality of code tables for said Asian languages, comprising Chinese and Japanese languages.

25. The method of claim 24, wherein said code tables for the Chinese language comprise two code tables, classical and modern Chinese.

26. The method of claim 24, wherein said code tables for the Japanese language comprise Hiragana, Katakana and Kanji.

27. The method of claim 16, wherein selecting said media type further comprises selecting pictures, video, TV, games and shopping amongst other types of media.

28. The method of claim 16, wherein said index database contains said descriptive identifier for said media files.

29. A Multilanguage multimedia system, comprising:
a) a means for inputting into a computer a code of a spoken language representing a descriptive identifier of a media file;
b) a means for communicating said code to a language input system for interpretation;
c) a means for locating said media file matching said code; and
d) a means for selecting and controlling a media player to play said media file.

30. The system of claim 29, wherein said means for inputting said code is a numeric keypad.

31. The system of claim 30, wherein said numeric keypad is contained on a unit remote from a computer containing said media file.

32. The system of claim 29, wherein said media file further comprises music, video or picture files.

33. The system of claim 29, wherein said code is a sequence of numbers representing consonants and syllables of said spoken language.

34. The system of claim 33, wherein said spoken language further comprises;
a) English;
b) Spanish;
c) European; and
d) Asian languages.

35. The system of claim 29, wherein said language input system interprets said code which further comprises:
a) a complete descriptive identifier;
b) a partial descriptive identifier; and
c) a set of initials of words forming said descriptive identifier.

36. A method for selecting and playing a media file, comprising:
a) selecting a media button on a remote unit;
b) selecting a search mechanism to find a media file on a host computer;
c) entering a descriptive identifier code for a media file onto a numeric keypad of said remote unit and coupling said descriptive identifier code to said search mechanism;
d) searching a storage mechanism of the host computer for the media file;
e) activating a media program to play said media file upon finding the media file; and
f) controlling said media player with keyboard control keys and voice commands.

37. The method of claim 36, wherein selecting said media button activates a menu on a display screen of said host computer to select the mode by which a media file is found and subsequently read by said media program.

38. The method of claim 36, wherein said search mechanism further comprises:
a) a full code input system;
b) a partial code input system;
c) an initial code input system; and
d) said full code, partial code and initial code input systems interpret code entry from the numeric keypad of the remote unit to form said descriptive identifier of said media file.

39. The method of claim 36, wherein activating said media program is an automatic response to finding said media file whereupon said media file is displayed by said media program on a display screen coupled to said host computer.

40. A method for establishing an input to a host computer, comprising:
a) selecting verbal command, key entry or audio input;
b) coupling verbal commands from a remote unit to speech pattern recognition in a host computer, and mapping results of the speech recognition into a keyboard code for said verbal commands;
c) coupling a key entry code from said remote unit to a keyboard mapping function to map said key entry code into code recognized by the media application;
d) coupling said keyboard mapping of text entry to a linguistic input method editor (LIME); and
e) coupling said audio input from said remote unit to an audio application residing in said host computer.

41. the method of claim 40, wherein mapping said results of the speech recognition into the keyboard code for said verbal commands is further coupled to said keyboard mapping to translate the keyboard code for said verbal commands recognized by the media application.

42. The method of claim 40, wherein said LIME interprets key code from a numeric keypad of said remote unit to formulate a descriptive identifier of a media file to identify and select said media file to be played on a media program resident in said host computer.

43. The method of claim 40, where in said verbal commands are used to control media programs operating on said host computer.

44. A method of media file management, comprising:
a) providing a key entry from a remote unit coupled to a host computer;
b) displaying a media play list;
c) selecting a media file and playing said media file on a media player;
d) activating an Internet search for said media file if said media file not found in said play list;
e) downloading said media file from the Internet and extracting media file descriptive identifying information to update a media access index; and
f) returning to said key entry after playing said media file or when said search does not find said media file.

45. The method of claim 44, wherein said extracting media file descriptive identifying information further comprises:
a) title of said media file,
b) artist or performer,
c) category; and
d) date.

46. The method of claim 44, wherein playing said media file on a media player places said media file on a frequent play list.

47. A method of fast indexing for media playback, comprising:
a) choosing a media type;
b) entering a descriptive identifier;
c) finding said media file on a media file index;
d) playing said media file; and
e) returning to user interface.

48. The method of claim 47, wherein choosing said media type further comprises amongst other media types video, movie, games, music, pictures, and learning programs.

49. The method of claim 47, wherein entering said descriptive identifier couples a series of key codes that translate into full phrases, partial phrases or initials of words that form said descriptive identifier and coupled to a linguistic input method editor to enable a search for a media file.

50. The method of claim 47, wherein playing said media file further comprises bringing said media file into memory from a media data base to be played on a media program using said media file index to locate said media file.

51. A method of automatic keyboard mapping, comprising:
a) issuing a keystroke or a verbal command from a remote unit coupled to a host computer;
b) checking for the existence of a mapping file;
c) switching automatically to an appropriate mapping file if the mapping file exists on said host computer and continuing to issue commands;
d) selecting keyboard default mapping automatically if on-demand download of keyboard mapping is not allowed and continuing to issue commands;
e) producing an alert to a user if on-demand download of keyboard mapping is allowed and downloading said keyboard mapping file from the Internet; and
f) selecting keyboard default mapping if a failure occurs in attempting to download said keyboard mapping file from the Internet.

52. The method of claim 51, wherein switching automatically to the appropriate mapping file is determined by the application that is to be used to play a media file.

53. The method of claim 51, wherein producing the alert notifies a user that an Internet download of said keyboard mapping file is about to commence.

54. The method of claim 51, downloading said keyboard mapping file adds said keyboard mapping file for an application to available mapping files of the host computer, and after the keyboard mapping file is downloaded and installed issuing of commands continue.
